(19) United States
(12) Patent Application Publication
(10) Pub. No.: US 2008/0195633 A1
(43) Pub. Date: Aug. 14, 2008

(54) Management of Vertical Sales and Agent Referrals

(76) Inventors: Brian Rose, Atlanta, GA (US); Karthiksundar Sankaran, Alpharetta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/619,415

(22) Filed: Jan. 3, 2007

(51) Int. Cl. G06F 17/30; G06Q 10/00; G06Q 30/00

(52) U.S. Cl. 707/100; 705/1; 705/26; 707/E17.005

(57) ABSTRACT

Methods, systems, and computer-readable media provide for the management of vertical sales and sales agent vertical product referrals. According to implementations, transaction data corresponding to the sale of a product to a customer is received. Vertical product information corresponding to the transaction data is retrieved. A correspondence is created that includes the vertical product information and a link that includes qualification data for authorizing a vertical product purchase and that links to an order form for the vertical product. The correspondence is transmitted to the customer. An indication of the link selection may be received. The customer qualifications may be verified and a vertical product order form sent to the customer. Indications of opening the correspondence, selecting the link, and completing the order form may be associated with the sales agent and stored in an entry of a database for use by a reporting application for searching and reporting.

### TECHNICAL FIELD

This application relates generally to managing vertical sales activities. More particularly, this application relates to referring vertical products to a customer and tracking any subsequent customer actions relating to the referral.

### BACKGROUND

Companies often use sales agents to contact potential customers or existing customers in an effort to sell them new or additional products and services. Typically, a company will target sales of a particular product, service, or group of products or services. The targeted product or service is sometimes a foundation for vertical products or services that depend on the customer receiving the targeted product or service. However, because the targeted product or service has a higher percentage of sales success and return on investment for the company than the vertical products or services, which consequently translates into higher commissions or sales statistics for the sales agent, the sales agent may be reluctant or not allowed to spend time promoting the vertical products or services.

If the sales agent does offer promotional material or recommendations to a customer regarding vertical products or services, and the customer signs up for one or more of those vertical products or services at a later date, then the sales agent typically has no method by which to receive credit for the sale. Additionally, it is difficult to track the effectiveness of the agent in promoting vertical products or services when an order of a vertical product or service is not linked to a sale of a targeted product or to a sales agent.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to embodiments of the disclosure presented herein, a method provides for the management of vertical product sales. According to the method, transaction data is received that corresponds to a sale of a product to a customer. Vertical product information that is related to the transaction data is retrieved and placed in an electronic correspondence, which is transmitted to the customer. This correspondence also includes a selectable link to a vertical product order form. The link includes qualification data that is used for authorizing the purchase of the vertical products. According to various implementations, the vertical product order form is transmitted to the customer in response to receiving a selection of the link in the electronic correspondence. A completed vertical product order form is received for the customer and submitted for processing.

According to further embodiments described herein, the qualification data within the link to the vertical product order form may include an identification of the product sold to the customer. When the link is selected, the product identification within the link is used to verify the qualifications of the customer to order the requested vertical product. According to various implementations, information within the electronic correspondence is stored within a transaction data entry of a customer database. When an indicator that the customer has completed the vertical product order form is received, this indicator is stored within the database entry. A request for a report having vertical product ordering information associated with the completion of the vertical product order may be received. In response, the customer database is searched for the requested vertical product ordering information and the requested report containing any located vertical product ordering information is provided.

According to further embodiments of the disclosure provided herein, an identification of a sales agent associated with the sale of the product to the customer is retrieved from the link within the electronic correspondence when the customer completes the vertical product order form. Data representing a vertical product sale by the identified sales agent is stored within the transaction data entry in the customer database. A number of vertical product sales by the sales agent during a period of time may be provided after receiving a request for the information and searching the customer database for the information.

Other systems, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a network diagram showing an illustrative operating environment for the processes and computer systems described herein and several of the software and data components utilized by the computer systems described herein;

FIG. 2 is a sales agent interface utilizing a referral template showing customer and agent information input fields and vertical product selections according to one embodiment presented herein;

FIG. 3 is an electronic mail referral showing vertical product information and ordering links for vertical products according to one embodiment presented herein;

FIGS. 4A-4C are flow diagrams illustrating a method for managing vertical sales according to one embodiment presented herein; and

FIG. 5 is a computer architecture diagram showing a computer architecture suitable for implementing the various computer systems described herein.

### DETAILED DESCRIPTION

The following detailed description is directed to methods, systems, and computer-readable media for managing vertical sales of products and services. In the following detailed description, references are made to the accompanying drawings that form a part hereof, and which are shown by way of illustration specific embodiments or examples.

Implementations of the disclosure presented herein allow a company, and a sales agent in particular, to sell a product or service to a customer, follow up the sale with a referral correspondence that includes targeted information pertaining to other vertical products and services that are related to or dependent upon the original product or service sold, facilitate the process of ordering the vertical products or services for the customer by including links within the correspondence that expedite the product verification and qualification process, and then track the referral and ordering process, collecting data that can be used for analysis or for compensation purposes. As used herein, a “product” may include any product, service, and combination thereof. Additionally, as used herein, a “vertical product” includes a product, service, or combination thereof that is related to or is dependent upon another product, service, or combination thereof. For example, a Voice Over Internet Protocol (VOIP) telephone service would be a vertical product of an Internet service since a VOIP telephone service could not exist without having an Internet service in place. It should be understood that while this disclosure is described in terms of vertical products, implementations of the disclosure are equally applicable to unrelated products and services.

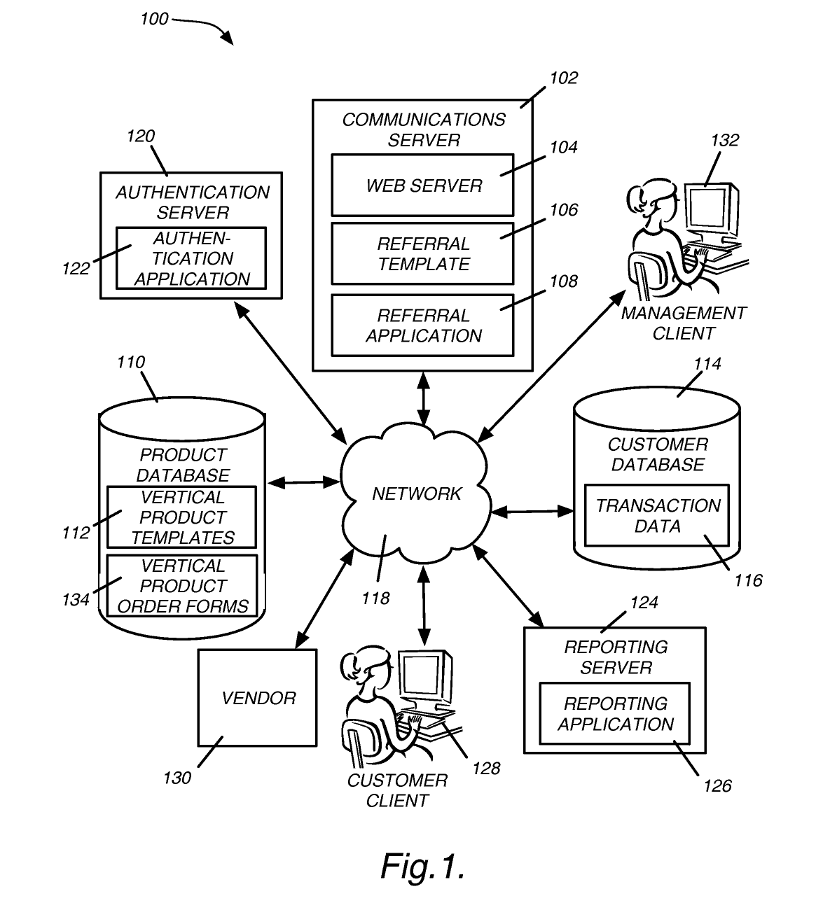

Referring now to the drawings, in which like numerals represent like elements through the several figures, aspects of the methods, systems, and computer-readable media provided herein will be described. FIG. 1 shows elements of an operating environment 100 for the processes and computer systems described herein, as well as several of the software and data components utilized by the computer systems according to various implementations. The elements of the operating environment 100 are shown to communicate with one another via a network 118. The network 118 may include a wireless network such as, but not limited to, a Wireless Local Area Network (WLAN) such as a WI-FI network, a Wireless Wide Area Network (WWAN), a Wireless Personal Area Network (WPAN) such as BLUETOOTH, a Wireless Metropolitan Area Network (WMAN) such a WiMAX network, a cellular network, or a satellite network. Alternatively, the network 118 may be a wired network such as, but not limited to, a wired Wide Area Network (WAN), a wired Local Area Network (LAN) such as the Ethernet, a wired Personal Area Network (PAN), or a wired Metropolitan Area Network (MAN). The network 118 may include the Internet such that the elements of the operating environment 100 communicate with one another via wireless or wired connections to the Internet.

It should be understood that the elements of the operating environment 100 may communicate using multiple networks 118 of differing types. It should also be understood that although servers 102, 120, and 124 are shown to be separate server computers, they may be a single server computer or any number of server computers. Similarly, although two databases, 110 and 114 are shown, the information stored within the databases 110 and 114 may alternatively be stored in a single database, multiple databases, or may be stored within a memory or mass storage device of one or more server computers 102, 120, and 124.

Additionally, applications 108, 122, and 126 may be a single application residing on any server computer 102, 120, or 124, or may be any number of applications residing on any combination of server computers 102, 120, or 124. The specific elements of the operating environment 100 are configured and designated as shown in FIG. 1 for clarity and illustrative purposes. However, it should be understood that the specific elements of the operating environment 100 may be configured according to any number of computing devices, applications, and databases according to various embodiments without departing from the scope of the disclosure presented herein.

For clarity, an illustrative process for referring vertical products to a customer and for tracking and analyzing subsequent actions taken by the customer according to the disclosure presented herein will be generally described with regard to the various elements of the operating environment 100. The illustrative example begins with a sales agent for a company contacting a customer in an effort to sell a product. This contact may be a personal visit to the home or business of the customer, a phone call to the customer, or communications via a management client computer 132 and a customer client computer 128. After successfully selling the product to the customer, the sales agent uses the management client computer 132 to request a referral template 106. The referral template 106 may be provided to the management client computer 132 utilizing a Web server program 104 located on the communications server 102 for providing requested documents, such as Web pages, to requesting client computers.

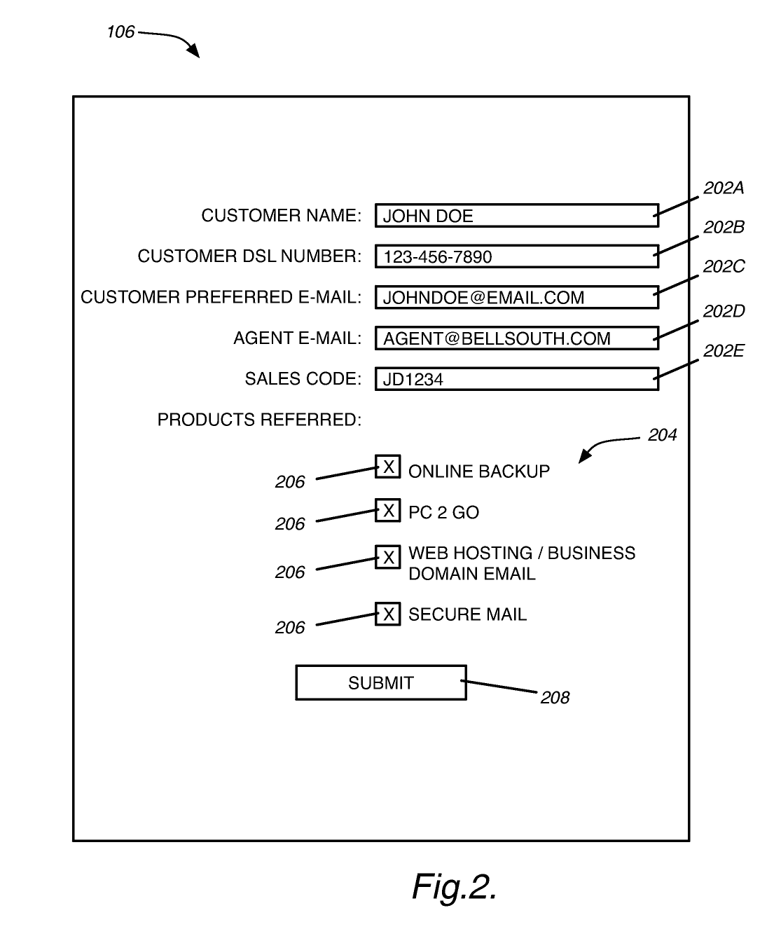

According to one embodiment, the Web server program 104 delivers the referral template 106 to the management client computer 132 as a Web page via the Internet. In this manner, the sales agent may access referral templates 106 on any management client computer 132 having a Web browser program for rendering Web pages sent from the Web server program 104 at the communications server 102. The referral template 106 includes a user interface for receiving information corresponding to the sale of the product to the customer. As an example, this information may include information related to the customer, information related to the sales agent, information related to the product sold, and information related to requested vertical products. The referral template 106 will be described in detail below with respect to FIG. 2.

After filling in the referral template 106 with the applicable information, the sales agent submits the completed referral template 106 to the communications server 102. The referral application 108 executed by the communications server 102 stores a portion of the information within the referral template 106 in the customer database 114 as transaction data 116. According to various implementations, the transaction data 116 may include customer information such as a name, customer number, or other identifying information, as well as a telephone number, an address, and a preferred method of contact for the customer. Additionally, the transaction data 116 may include information associated with the sales agent such as a name, sales code, or other identifying information. The transaction data 116 may further comprise information corresponding to the product sold or to the vertical products of interest.

It should be appreciated that embodiments are not limited to the types of information described herein, but rather may include any amount and type of information regarding the customer, the sales agent, the product sold, any vertical products of interest, and/or the product transaction. As will be described in further detail below, the transaction data 116 corresponding to any number of sales transactions may be stored as transaction data entries within the customer database 114 that may be searched and sorted by the reporting application 126 residing on the reporting server 124 according to instructions from a manager or sales agent via the management client computer 132.

In addition to storing the transaction data 116 from the completed referral template 106 in the customer database 114, the referral application 108 retrieves vertical product templates 112 from the product database 110. The referral application 108 utilizes information within the referral template 106 to select the appropriate vertical product templates 112 to retrieve. Specifically, as will be described below with respect to FIG. 2, the referral template 106 includes a selection of appropriate vertical products corresponding to the product sold to the customer. The referral application 108 retrieves the vertical product templates 112 according to the identified vertical products in the referral template 106.

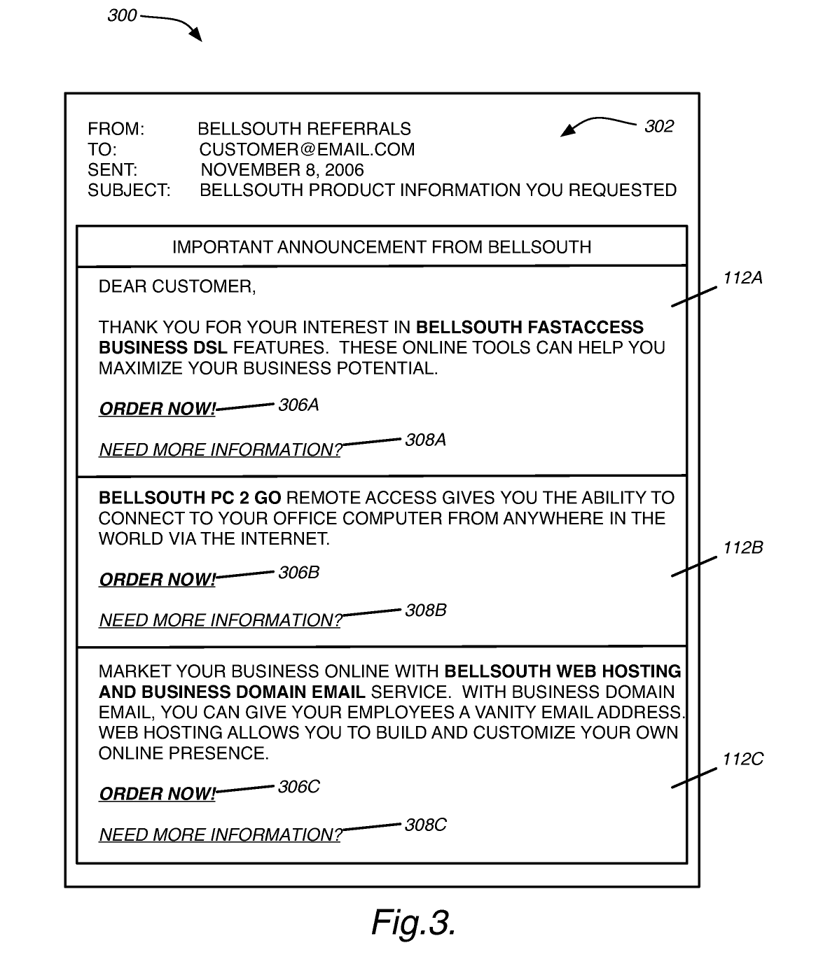

The vertical product templates 112 provide marketing information and any other desired information regarding the vertical products requested in the referral template 106. According to embodiments presented herein, each vertical product template 112 corresponds to a vertical product or group of products that may be sold together as a unit. The information within each vertical product template 112 may include a product description and price, a description of key product features, a Uniform Resource Locator (URL) or other link to an internal or external vendor 130 providing the vertical product, and qualification criteria. As described above, the qualification criteria may identify the required products that the customer must have purchased prior to purchasing the vertical product corresponding to the vertical product template 112. It should be understood that the information contained in each vertical product template 112 may be changed by any authorized sales agent or other manager at any time as prices, promotions, and marketing strategies change, and then stored in the products database 110 for inclusion in correspondence to customers as described below with respect to FIG. 3.

After retrieving the appropriate vertical product templates 112, the referral application 108 generates a referral electronic mail (E-mail) to be sent to the customer client computer 128 associated with the customer. It should be understood that the customer client computer 128 and the management client computer 132 may be any computing device capable of receiving and transmitting data and accepting user input. As an example, the client computers 128 and 132 may each be a Personal Computer (PC), a laptop computer, a cellular telephone, a Personal Data Assistant (PDA), or any other type of mobile or stationary proprietary computing device developed for the purpose of this disclosure.

The referral E-mail includes the information provided in the vertical product templates 112. The contents of the referral E-mail will be discussed in greater detail below with respect to FIG. 3. As stated above, each vertical product template 112 includes a link containing a URL that, when selected, provides product information to an authentication server 120 for verification by an authentication application 122 that the customer is qualified to receive an associated vertical product. To provide this functionality, the referral application 108 embeds qualification data derived from the completed referral template 106 into the URL or other link for each vertical product template 112. The embedded qualification data may include an identification of the product purchased, as well as identifying information associated with the sales agent. For example, for a customer that purchased Digital Subscriber Line (DSL) technology, the referral application 108 may insert the DSL number associated with the customer into the each URL that links to a vertical product order form 134 for each vertical product template 112 associated with the referred vertical products. It should be appreciated that the embedded qualification data may be encoded or encrypted for privacy purposes.

When the customer receives the referral E-mail at the customer client computer 128, she decides to order one of the vertical products. To do so, she clicks on the link having the URL associated with the desired vertical product using a computer mouse or other input device. By clicking on the link containing the URL, the customer sends an authentication request to the authentication server 120. The authentication application 122 extracts the embedded qualification data associated with the purchased product from the URL by decoding or decrypting the URL. This data is used to verify that the customer is qualified to purchase the requested vertical product based on the product purchased from the sales agent as well as any other qualifying criteria.

Instead of relating the product purchased from the sales agent, it should be understood that the qualification data that is embedded within the URL or other link to the vertical product order form 134 may relate to the customer or may relate to any existing products that the customer did not purchase from the sales agent. For example, the sales agent may choose to refer vertical products to the customer based on existing products that the customer owns but did not purchase from the sales agent. In this embodiment, the embedded qualification data within the URL may include any customer identifier that the authentication application 122 may use to reference a customer account profile that contains information relating to the customer and/or the products that the customer has subscribed to or purchased. The authentication application 122 uses the subscription and purchase information to determine whether the customer is qualified to purchase the requested vertical product. By embedding the qualification data within the URL, the authentication process occurs without any additional steps required by the customer. The customer is not required to manually enter a DSL number or other customer or product information in order to initiate the authentication process. Rather, the process occurs using the embedded qualification data without assistance from the customer.

Once the authentication application 122 verifies that the customer is qualified to purchase the requested vertical product, then the authentication application 122 retrieves the vertical product order form 134 from the product database 110 and transmits it to the customer client computer 128 for completion. The vertical product order form 134 may be pre-populated with information from the qualification data embedded within the URL, or from the customer account profile accessed by the authentication application 122 using the qualification data. When the customer has completed the vertical product order form 134, then the customer client computer 128 transmits the completed form to the vendor 130 for processing. It should be understood that the process of retrieving the vertical product template 112 from the product database 110 may be performed by any application residing on any element of the operating environment 100 and is not limited to the authentication application 122.

In an alternative embodiment, once the authentication application 122 verifies that the customer is qualified to purchase the requested vertical product, then the order request is transmitted to the vendor 130. The vendor 130 then provides the vertical product order form 134 to the customer for completion. When complete, the customer forwards the completed vertical product order form 134 back to the vendor 130 for processing. It should be appreciated that the authentication process may alternatively occur upon submission of the completed vertical product template 112 by the customer client computer 128 rather than prior to delivery of the vertical product template 112 to the customer client computer 128.

As stated above, any action taken by the customer at the customer client computer 128 may be stored as a transaction data entry or within a transaction data entry in the customer database 114. For example, when the customer opens the referral E-mail, an indication of this action is stored within the customer database 114 by the referral application 108 in much the same manner as when a person requests that an E-mail application provide a notification when an E-mail that has been sent to another party has been delivered or has been read. Similarly, when a customer selects a link to a URL within a referral E-mail in order to obtain additional information or to order a vertical product, this action is again represented in a transaction data entry of the customer database 114.

By storing these and other indications of actions taken by the customer, then a company or associated manager or sales agent may utilize the reporting application 126 within the reporting server 124 to search for and retrieve information related to specific transactions, to retrieve statistical information pertaining to a large group of referral E-mails or other transactions, to perform data mining operations, and to create reports, graphs, and presentations related to the sales of vertical products. For example, a manager at a company that is interested in the effectiveness of the referral E-mail system that the company has adopted may utilize the management client computer 132 to request a report of all vertical product orders placed by clicking on a link to a URL within a referral E-mail over the last 90 days. In response to this request, the reporting application 126 searches the transaction data entries within the customer database for all instances within the previous 90 days wherein a referral E-mail was sent, a link to a URL was clicked on within the referral E-mail, and a vertical product order form 134 was subsequently transmitted to the vendor 130.

Turning now to FIG. 2, an example of the referral template 106 is shown. According to embodiments presented herein, the referral template 106 includes a customer name input field 202A, a customer DSL number input field 202B, a preferred customer E-mail address input field 202C, a sales agent E-mail address input field 202D, and a sales code input field 202E. It should be appreciated that the disclosure presented herein is not limited to the input fields 202A-202E. Any amount and type of data that may be helpful in targeting appropriate vertical product templates 112 to the customer and tracking the purchases by the customer while associating subsequent purchases of vertical products with the sales agent that referred the vertical products to the customer may be included on the referral template 106.

The customer name input field 202A is the location for entering the name of the customer. The customer DSL number input field 202B is the location for entering the DSL number associated with the customer. In this example, the sales agent sold DSL service to the customer. This DSL number is used to identify the product sold so that appropriate vertical products may be referred. It should be appreciated that any other product identifier may be entered into the input field 202B if DSL is not the product sold to the customer. The agent E-mail address input field 202D is for entering a means for contacting the sales agent, specifically an associated E-mail address. The sales code input field 202E identifies the sales agent so that the agent may receive credit for any sales of a vertical product after selling a product to the customer and sending the associated referral E-mail.

As stated above, the embedded qualification data may include identifying information associated with the sales agent. According to one embodiment, this identifying information is the sales code entered into the sales code input field 202E. The referral application 108 embeds the sales code into the URL and stores this code with the indication of a customer action in a transaction data entry of the customer database 114. By doing so, a manager or sales agent may associate vertical product sales with the sales agent that sold them the initial product and sent them the referral E-mail. Alternatively, if the sales code or other identifying information associated with the sales agent is not embedded into the URL as qualification data, then the referral application 108 may cross-reference the completed referral template 106 for the sales agent information whenever an action by the customer is detected. It should be appreciated that the sales code and any other identifying information associated with the sales agent may be stored as a cookie by a web browser associated with the sales agent. By doing so, the sales code input field 202E and any other input field for receiving sales agent information may be populated using the information stored within the cookie so that the sales agent does not have to input the information each time a referral template 106 is filled out.

The referral template 106 includes a referred products list 204. The referred products list 204 includes one or more vertical products that relate to the product sold to the customer by the sales agent or to any existing product associated with the customer. This referred products list 204 may include a predetermined number of vertical products selected according to a priority system as determined by the company or sales agent, according to the likelihood of sales success according to the purchase history of the customer, demographic data, or other customer or community characteristics, or according to any other criteria as determined by the company or sales agent. The vertical products included in the referred products list 204 of the referral template 106 may be selected manually by the sales agent or using logic programmed into the referral application 108. If the referred products list 204 is populated by the referral application 108, then the sales agent may have the option to select which vertical products on the list 204 to include in the referral E-mail to the customer. The sales agent may make this selection using the selection buttons 206 corresponding to the desired vertical products on the referred products list 204. The referred products list 204 allows the sales agent to easily add and delete vertical product templates 112 from the referral E-mail to be discussed below. Once the sales agent completes the referral template 106, the agent may initiate the retrieval of the corresponding vertical product templates 112 and the creation of the referral E-mail by selecting the submit button 208.

FIG. 3 shows an example of a referral E-mail 300 according to the disclosure presented herein. The referral E-mail 300 includes a header 302 that has information corresponding to the sending party, the receiving party, the date, and the subject of the referral E-mail 300. The referral E-mail 300 also includes one vertical product template 112 for each vertical product chosen in the referred products list 204 of the referral template 106 for inclusion in the referral E-mail 300. The sample referral E-mail 300 shown in FIG. 3 includes vertical product templates 112A-112C corresponding to BELLSOUTH FASTACCESS BUSINESS DSL, BELLSOUTH PC 2 GO, and BELLSOUTH WEB HOSTING AND BUSINESS DOMAIN EMAIL vertical products, respectively. It should be noted that a single electronic correspondence may be sent to a customer that contains any number of vertical product templates 112A-112C corresponding to any number of products.

Each vertical product template 112A-112C includes an ordering link 306A-306C, respectively, to a URL used for authentication and ordering as described above. If the customer chooses to order one or more of the vertical products described in the referral E-mail 300, then she can click on the applicable link 306A-306C corresponding to the desired product. Similarly, each vertical product template 112A-112C includes an information link 308A-308C, respectively, to a URL used to retrieve additional information regarding the vertical product that is stored in a document or as a Web page in the product database 110. The sample E-mail 300 shown in FIG. 3 is a representation of the correspondence that a customer would receive as a result of purchasing a product such as DSL service. Because the ordering links 306A-306C include embedded data corresponding to the purchased product and the corresponding sales agent, the authentication process is simplified for the customer and the sales agent may make referrals and accurately track the success of those referrals.

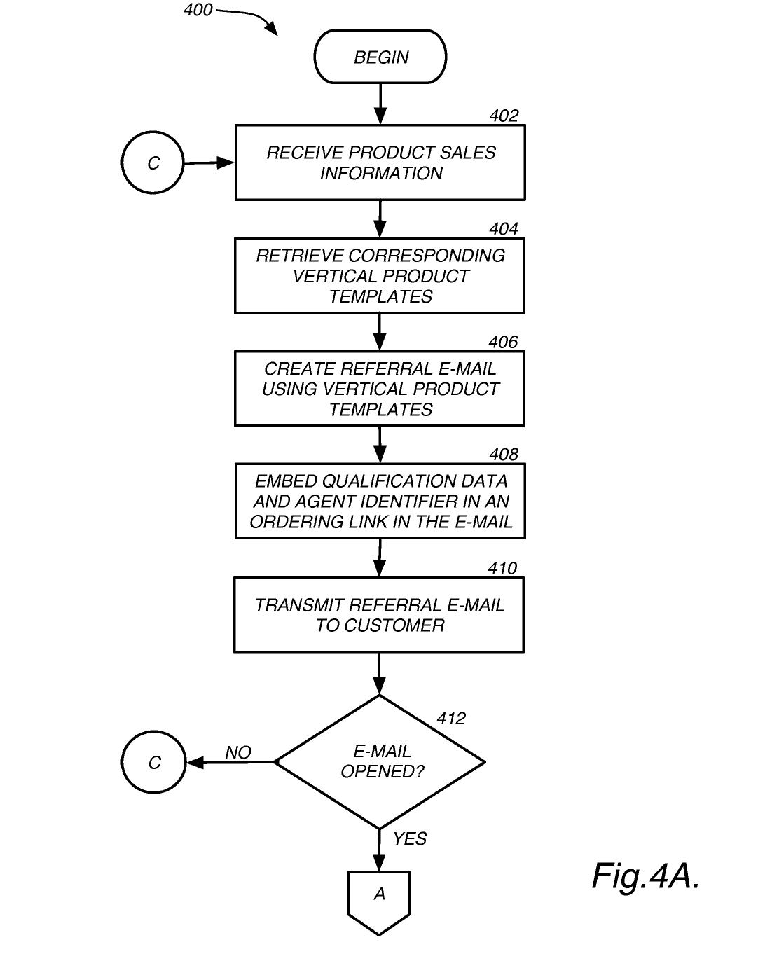

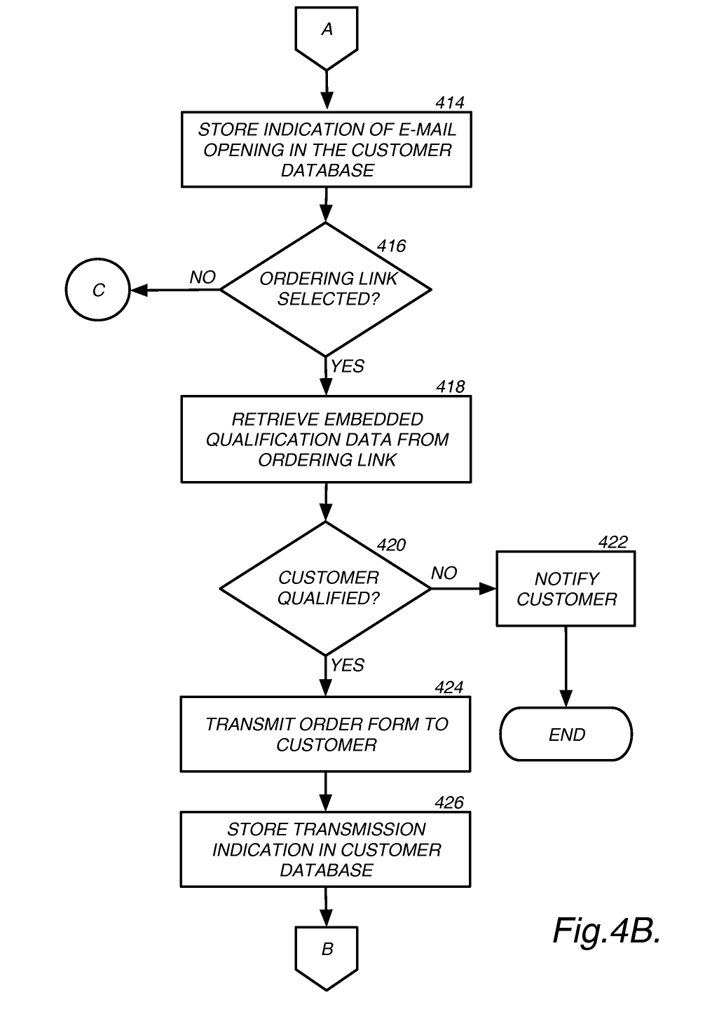

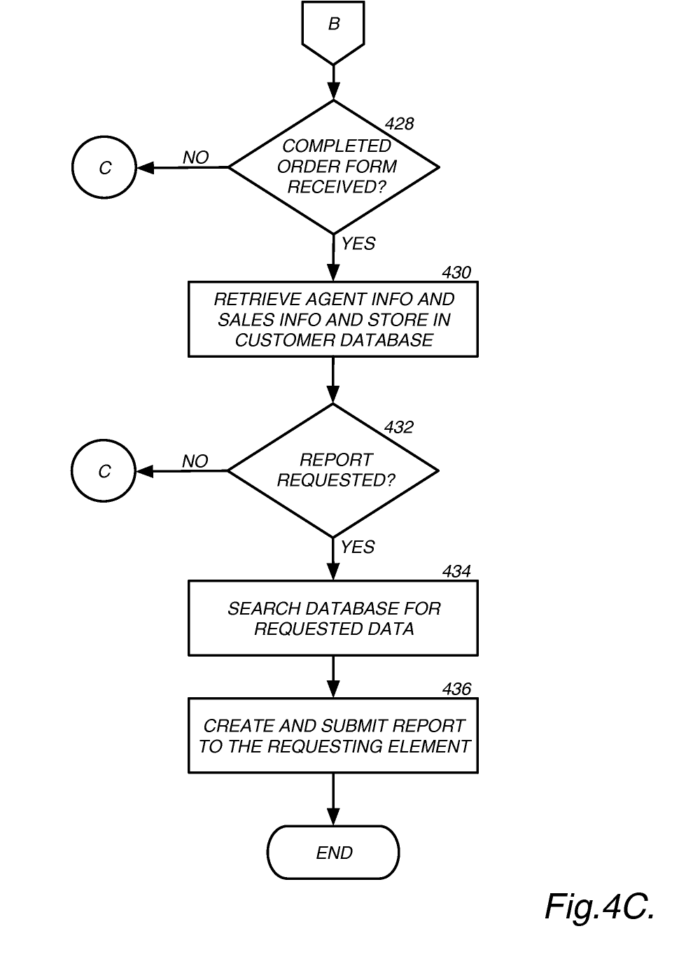

Referring now to FIG. 4, an illustrative routine 400 will be described for managing vertical sales according to one embodiment presented herein. It should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 400 begins at operation 402, where the referral application 108 receives product sales information via the referral template 106. As discussed above, the Web server program 104 provides a front end user interface in the form of a Web page or other document delivered to the management client computer 132 for receiving the product sales information from the sales agent. The routine 400 continues from operation 402 to operation 404, where the referral application 108 retrieves the vertical product templates 112 from the product database 110 corresponding to the vertical products listed in the referred vertical products list 204 of the referral template 106. From operation 404, the routine 400 proceeds to operation 406, where the referral application 108 creates a customized referral E-mail 300 that includes the vertical product templates 112A-112C retrieved from the product database 110. The routine 400 continues from operation 406 to operation 408, where the referral application 108 embeds qualification data and a sales agent identifier in a URL associated with each ordering link 306A-306C of the vertical product templates 112A-112C in the referral E-mail 300.

From operation 408, the routine 400 proceeds to operation 410, where the referral application 108 transmits the referral E-mail 300 to the customer client computer 128 associated with the customer. The preferred E-mail address for the customer is requested by the sales agent at the time of the product sale and is entered into the preferred E-mail address input field 202C of the referral template 106. In this manner, the referral E-mail 300 is likely to reach the customer since the E-mail address is obtained directly from the customer. The routine 400 continues to operation 412, where the referral application 108 makes a determination as to whether the customer opened the referral E-mail 300. If the referral application 108 determines that the customer did not open the referral E-mail 300, then the routine 400 returns to operation 402 and proceeds as described above. However, if at operation 412, the referral application 108 determines that the customer has opened the referral E-mail 300, then the routine 400 proceeds to operation 414, where the referral application stores an indication of the opening of the referral E-mail 300 in a transaction data entry of the customer database 114.

As described above, this indication may be associated with the corresponding sales agent or other customer information prior to storing the transaction data entry in the customer database 114 in an effort to create an extensive database 114 of product sales and vertical product sales information. The information in the database 114 may then be tracked, sorted, and analyzed by managers or sales agents and used to track sales agent performance measures. From operation 414, the routine 400 continues to operation 416, where the referral application 108 determines whether the customer has selected an ordering link 306A-306C. If the referral application 108 determines that the customer has not selected an ordering link 306A-306C, then the routine 400 returns to operation 402 and proceeds as described above. However, if at operation 416, the referral application 108 determines that the customer selected an ordering link 306A-306C, then the routine 400 continues to operation 418, where the authentication application 122 retrieves the embedded qualification data within the ordering link. Using the authentication process described above, at operation 420, the authentication application 122 utilizes the embedded data to determine whether the customer is qualified to purchase the requested vertical product.

If at operation 420, the authentication application 122 determines that the customer is not qualified to purchase the requested vertical product, then the routine 400 continues to operation 422, where the authentication application 122 notifies the customer that she is not qualified for purchasing the vertical product along with the reason for the failed qualification and any other pertinent or desired information. After notifying the customer, the routine 400 ends. However, if at operation 420, the authentication application 122 determines that the customer is qualified to purchase the requested vertical product, then the routine 400 proceeds to operation 424, where the authentication application 122 retrieves the applicable vertical product order form 134 and transmits it to the customer. It should be appreciated that the vertical product order form 134 retrieval and transmission action may be executed by the referral application 108 or by the vendor 130 rather than by the authentication application 122. The routine 400 continues from operation 424 to operation 426, where the referral application 108 stores an indication of the vertical product order form 134 transmission in a transaction data entry of the customer database 114.

From operation 426, the routine 400 proceeds to operation 428, where the referral application 108 determines whether the vendor 130 received a completed vertical product order form 134. It should be understood that this determination may be made using various methods. First, the customer may transmit the completed vertical product order form 134 directly to the vendor 130 for processing. The vendor 130 then notifies the referral application 108, the authentication application 122, the reporting application 126, or the management client computer 132 that the completed vertical product order form 134 has been received. The receipt of the completed vertical product order form 134 is then stored in a transaction data entry of the customer database 114 by the notified element. Another method for determining whether the vendor 130 received a completed vertical product order form 134 is that the completed vertical product order form 134 is transmitted from the customer client computer 128 to the referral application 108, the authentication application 122, the reporting application 126, or the management client computer 132. The receiving element then stores an indication of the completed vertical product order form 134 in a transaction data entry of the customer database 114 and forwards the completed vertical product order form 134 to the vendor 130 for processing.

From operation 428, the routine 400 continues to operation 430, where the referral application 108 retrieves the sales agent information from the embedded data within the appropriate ordering link 306A-306C or from the associated referral template 106, as well as the sales information relating to the sale of the vertical product, and stores the collective information in a transaction data entry of the customer database 114. The routine 400 proceeds from operation 430 to operation 432, where the reporting application 126 determines whether a report has been requested. If a report has not been requested, then the routine 400 returns to operation 402 and proceeds as described above. However, if at operation 432, the reporting application 126 determines that a report has been requested, then the routine 400 continues to operation 434, where the reporting application 126 searches the customer database 114 for the data associated with the requested report. At operation 436, the reporting application 126 creates and submits the requested report to the requesting element and the routine 400 ends.

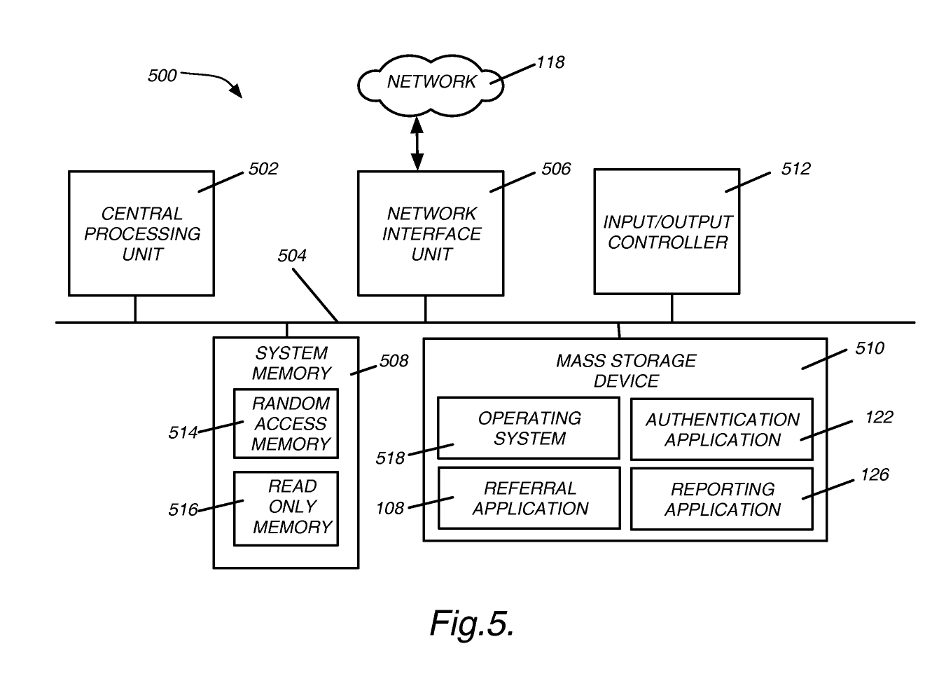

Referring now to FIG. 5, an illustrative computer architecture for a computer 500 utilized in the various embodiments presented herein will be discussed. The computer architecture shown in FIG. 5 illustrates a conventional desktop computer 128 or 132, laptop computer, or server computer 102, 120, or 124. The computer architecture shown in FIG. 5 includes a Central Processing Unit 502 (CPU), a system memory 508, including a Random Access Memory 514 (RAM) and a Read-Only Memory (ROM) 516, and a system bus 504 that couples the memory to the CPU 502. A basic input/output system containing the basic routines that help to transfer information between elements within the computer 500, such as during startup, is stored in the ROM 516. The computer 500 further includes a mass storage device 510 for storing an operating system 518 and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available media that can be accessed by the computer 500.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, Digital Versatile Disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through the network 118. The computer 500 may connect to the network 118 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including the operating system 518 suitable for controlling the operation of a networked desktop or server computer. The mass storage device 510 and RAM 514 may also store one or more program modules. In particular, the mass storage device 510 and the RAM 514 may store the referral application 108, the authentication application 122, the reporting application 126, or any combination thereof. Other program modules may also be stored in the mass storage device 510 and utilized by the computer 500.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for managing vertical sales, comprising:
receiving transaction data corresponding to a sale of a product to a customer;
retrieving vertical product information corresponding to the transaction data;
creating an electronic correspondence comprising the vertical product information and a selectable link to a vertical product order form, wherein the link comprises qualification data for authorizing the purchase of a vertical product associated with the vertical product order form; and
transmitting the electronic correspondence to the customer.

2. The method of claim 1, further comprising:
receiving a selection of the link to the vertical product order form;
as a result of receiving the selection of the link, transmitting the vertical product order form to the customer;
receiving a completed vertical product order form from the customer; and
submitting the completed vertical product order form to a processing element for processing.

3. The method of claim 2, wherein the qualification data within the link comprises a product identifier corresponding to the product sold to the customer, and wherein transmitting the vertical product order form comprises utilizing the product identifier to verify the qualifications of the customer to order the vertical product.

4. The method of claim 2, further comprising:
storing a transaction data entry in a customer database, the entry comprising information associated with contents of the electronic correspondence;
receiving an indicator that the customer has completed the vertical product order form;
storing the order completion indicator in the transaction data entry of the customer database;
receiving a request for a report comprising vertical product ordering information associated with the order completion indicator;
searching the customer database for the requested vertical product ordering information; and
providing the requested report comprising the vertical product ordering information.

5. The method of claim 4, wherein the link further comprises a sales agent identifier corresponding to a sales agent that sold the product to the customer, and wherein the method further comprises:
in response to receiving the indicator that the customer has completed the vertical product order form, retrieving the sales agent identifier from the link;
storing data representing a vertical product sale by the identified sales agent in the transaction data entry in the customer database;
receiving a request for a number of vertical product sales by the sales agent during a period of time;
searching the customer database for transaction data entries comprising data representing a vertical product sale by the sales agent during the requested period of time; and
providing the number of vertical product sales by the sales agent during the requested period of time.

6. The method of claim 1, wherein the transaction data comprises a sales agent identifier, a customer identifier, and information corresponding to the product sold.

7. The method of claim 1, further comprising:
storing a transaction data entry in a customer database, the transaction data entry comprising information associated with contents of the electronic correspondence;
receiving an indicator that the customer has opened the electronic correspondence;
storing the correspondence opening indicator in the transaction data entry of the customer database;
receiving a request for a report comprising electronic correspondence opening information associated with the correspondence opening indicator;
searching the customer database for the requested electronic correspondence opening information; and
providing the requested report comprising the electronic correspondence opening information.

8. A computer-readable medium having computer-executable instructions stored thereon which, when executed by a computer, cause the computer to:
receive transaction data corresponding to a sale of a product to a customer;
retrieve vertical product information corresponding to the transaction data;
create an electronic correspondence comprising the vertical product information and a selectable link to a vertical product order form, wherein the link comprises qualification data for authorizing the purchase of a vertical product associated with the vertical product order form; and
transmit the electronic correspondence to the customer.

9. The computer-readable medium of claim 8, further comprising computer-executable instructions stored thereon which, when executed by a computer, cause the computer to:
receive a selection of the link to the vertical product order form;
as a result of receiving the selection of the link, transmit the vertical product order form to the customer;
receive a completed vertical product order form from the customer; and
submit the completed vertical product order form to a processing element for processing.

10. The computer-readable medium of claim 9, wherein the qualification data within the link comprises a product identifier corresponding to the product sold to the customer, and wherein causing the computer to transmit the vertical product order form comprises causing the computer to utilize the product identifier to verify the qualifications of the customer to order the vertical product.

11. The computer-readable medium of claim 9, further comprising computer-executable instructions stored thereon which, when executed by a computer, cause the computer to:
store a transaction data entry in a customer database, the transaction data entry comprising information associated with contents of the electronic correspondence;
receive an indicator that the customer has completed the vertical product order form;
store the order completion indicator in the transaction data entry of the customer database;
receive a request for a report comprising vertical product ordering information associated with the order completion indicator;
search the customer database for the requested vertical product ordering information; and
provide the requested report comprising the vertical product ordering information.

12. The computer-readable medium of claim 11, further comprising computer-executable instructions stored thereon which, when executed by a computer, cause the computer to:
in response to receiving the indicator that the customer has completed the vertical product order form, retrieve a sales agent identifier from the transaction data corresponding to a sales agent that sold the product to the customer;
store data representing a vertical product sale by the identified sales agent in the transaction data entry in the customer database;
receive a request for a number of vertical product sales by the sales agent during a period of time;
search the customer database for transaction data entries comprising data representing a vertical product sale by the sales agent during the requested period of time; and
provide the number of vertical product sales by the sales agent during the requested period of time.

13. The computer-readable medium of claim 9, further comprising computer-executable instructions stored thereon which, when executed by a computer, cause the computer to:
store the transaction data corresponding to a sale of a product to a customer in a transaction data entry of a plurality of entries within a customer database, wherein each transaction data entry comprises transaction data associated with a product sale to a customer;
receive a request for statistical data corresponding to the plurality of transaction data entries;
calculate the requested statistical data; and
provide the requested statistical data to a requesting party.

14. The computer-readable medium of claim 8, further comprising computer-executable instructions stored thereon which, when executed by a computer, cause the computer to:
store a transaction data entry in a customer database, the entry comprising information associated with contents of the electronic correspondence;
receive an indicator that the customer has opened the electronic correspondence;
store the correspondence opening indicator in the transaction data entry of the customer database;
receive a request for a report comprising electronic correspondence opening information associated with the correspondence opening indicator;
search the customer database for the requested electronic correspondence opening information; and
provide the requested report comprising the electronic correspondence opening information.

15. A system for managing vertical sales within a network, comprising:
means for receiving transaction data corresponding to a sale of a product to a customer;
means for retrieving vertical product information corresponding to the transaction data;
means for creating an electronic correspondence comprising the vertical product information and a selectable link to a vertical product order form, wherein the link comprises qualification data for authorizing the purchase of a vertical product associated with the vertical product order form; and
means for transmitting the electronic correspondence to the customer.

16. The system of claim 15, further comprising:
means for receiving a selection of the link to the vertical product order form;
means for transmitting the vertical product order form to the customer as a result of receiving the selection of the link;
means for receiving a completed vertical product order form from the customer; and
means for submitting the completed vertical product order form to a processing element for processing.

17. The system of claim 16, wherein the qualification data within the link comprises a product identifier corresponding to the product sold to the customer, and wherein transmitting the vertical product order form comprises utilizing the product identifier to verify the qualifications of the customer to order the vertical product.

18. The system of claim 16, further comprising:
means for storing a transaction data entry in a customer database, the transaction data entry comprising information associated with contents of the electronic correspondence;
means for receiving an indicator that the customer has completed the vertical product order form;
means for storing the order completion indicator in the transaction data entry of the customer database;
means for receiving a request for a report comprising vertical product ordering information associated with the order completion indicator;
means for searching the customer database for the requested vertical product ordering information; and
means for providing the requested report comprising the vertical product ordering information.

19. The system of claim 15, further comprising:
means for retrieving a sales agent identifier from the transaction data corresponding to a sales agent that sold the product to the customer in response to receiving the indicator that the customer has completed the vertical product order form;
means for storing data representing a vertical product sale by the identified sales agent in the transaction data entry in the customer database;
means for receiving a request for a number of vertical product sales by the sales agent during a period of time;
means for searching the customer database for transaction data entries comprising data representing a vertical product sale by the sales agent during the requested period of time; and
means for providing the number of vertical product sales by the sales agent during the requested period of time.

20. The system of claim 15, wherein the transaction data comprises a sales agent identifier, a customer identifier, and information corresponding to the product sold.
